(19) United States
(12) Patent Application Publication
(10) Pub. No.: US 2005/0135244 A1
(43) Pub. Date: Jun. 23, 2005

(54) Wireless network load generator address mask manipulation

(75) Inventors: Douglas M. Miller, Santa Barbara, CA (US); Ken Balmy, Santa Barbara, CA (US); Jeff A. Bechdol, Santa Barbara, CA (US)

Correspondence Address: Richard D. Multer, PO Box 2384, Sheeton, WA, 98584, US

(73) Assignee: Comunication Machinery Corporation

(21) Appl. No.: 11/013,524

(22) Filed: Dec. 15, 2004

Related U.S. Application Data
(60) Provisional application No. 60/531,061, filed on Dec. 19, 2003.

(51) Int. Cl. H04B 1/44; H04L 12/28

(52) U.S. Cl. 370/229; 370/389; 370/282

(57) ABSTRACT

A method and system for using a single wireless network interface to selectively accept for further processing frames transmitted in a wireless data communications network. This allows a host system to emulate the operation of multiple, concurrently active stations in the wireless network. All wireless stations so emulated adhere to the requirements of applicable standard protocols; particularly, in the context of this innovation, with respect to contention for use of the communications medium and acceptance for further processing of frames transmitted on the medium to an emulated station from a communicating peer station. Each emulated station is assigned a unique address in accordance with the applicable standard protocol, which satisfies the characteristics of a programmable, masking address filter. The address filter allows the interface to accept frames addressed to a conforming emulated wireless station while ignoring other frames. This technique is useful in the creation of efficient systems which may thereby provide interface to the wireless medium concurrently on behalf of multiple emulated stations, giving the appearance from the network standpoint of multiple wireless stations which are all in fact operated within a single device.

### CROSS REFERENCE TO ANOTHER APPLICATION

This application is entitled to and claims the benefit of the filing date of provisional application No. 60/531,061 filed 19 Dec. 2003.

### TECHNICAL FIELD OF THE INVENTION

The present invention relates generally to the field of wireless data communications, and specifically to the emulation of multiple stations in a wireless network.

### BACKGROUND OF THE INVENTION

A wireless data communication network is characterized by two or more stations which share the use of a common wireless communications medium or channel to facilitate transmission of data packets or frames between communicating peers. Since the medium is shared among all stations in the network, some means of controlling access to the medium is required to prevent two stations from simultaneously attempting to control the medium. Wireless communication is further complicated by the lack of a tangible physical medium for making the connection between stations.

Communications must adhere to the protocols prescribed by the specifications applicable to the particular type of wireless communications network at hand. Such wireless standards specify a general format for data packets or frames transmitted on the network, as well as a protocol to be followed by communicating peers and other stations sharing the network medium.

The frame format typically includes an addressing mechanism to distinguish the frame intended to be received by a particular station on the network, in which case the other stations on the network may ignore the frame. To mitigate the vagaries of frame transmission in a wireless network, the receiving station is typically required to provide positive acknowledgment that it has successfully received the frame. The acknowledgment also informs other stations that the use of the medium for the current frame is now complete and the medium is now available for other use.

In some applications it is desirable to operate several stations within a single device. An illustrative example is a device which mimics the operation of a number of wireless stations for test purposes. In such applications the device emulates multiple wireless stations which appear from the network standpoint to be distinct nodes on the network, these nodes being concurrently active in accordance with protocol requirements.

One such device is disclosed in U.S. patent application Ser. No. 10/424,161 filed 25 Apr. 2003. The entire disclosure of the '161 application is hereby incorporated in this application by reference.

A fundamental problem to be solved in such a system is how to share the system's single wireless interface among the several emulated stations, and to do so in a way that satisfies the requirements of the particular wireless communications protocol; specifically, to generate proper acknowledgment for received frames and to receive acknowledgment for transmitted frames. This must be balanced against an economical system implementation which makes efficient use of available network communications bandwidth.

When exchanging frames on the wireless network, the receiver must send acknowledgement to the sender within an allotted response time. If the sender does not receive acknowledgment, it will attempt to resend the frame up to some maximum number of retries. Other stations on the wireless network may not use the medium until the acknowledgement is sent, up to some maximum duration. The acknowledgement/retry logic is typically implemented in the interface hardware to avoid the slower response time and additional processor overhead of a software implementation. The hardware is aware of its physical address and acknowledges frames transmitted from other stations to the station with that physical address.

A network interface may typically be set into a “promiscuous” mode in which it passively receives and may inspect all frames transmitted on the medium, whether or not they are addressed to the station in which the interface is installed. By placing the interface in the promiscuous mode, the system can be made aware of frames addressed to an emulated station and change the address in the interface hardware accordingly so that it will acknowledge the frame. In some cases this may cause sufficient delay in the acknowledgement as to result in the sender having to retry the transmission.

This same concept holds when transmitting frames: the interface must be aware of the address of the emulated station sending the frame so that it can properly receive the acknowledgement and thus prevent resending the frame unnecessarily.

By manipulating the address of the physical interface as outlined above, the wireless protocol is satisfied with respect to frame acknowledgement. However, this scheme does not make optimal use of the available communications bandwidth of the wireless network, because of the increased likelihood of retransmission of frames while awaiting acknowledgement. In addition, the processor of the host system must carry the extra burden of examining all frames placed on the channel, plus the additional overhead of switching the interface's physical address on a frame-by-frame basis.

There is therefore an outstanding and continuing need for a more efficient implementation of wireless station emulation which would allow a wireless data communication system to receive only frames which are addressed to any of the system's emulated stations, without requiring the constant address manipulation of the heretofore employed technique discussed above. Such a system would also desirably provide a timely acknowledgement of all frames thus received.

### SUMMARY OF THE INVENTION

Methods and systems with the important attributes just described have now been invented and are described herein.

Broadly stated, the present invention involves the innovative use of an address filter as a component in a wireless network load generator. The load generator is a testing device which leverages a single wireless network interface to emulate the operation of a configurable number of virtual wireless stations and generates network traffic on behalf of those emulated stations for purposes of verifying network capacity, scalability, and adherence to protocol requirements. The address filter is implemented in the form of a binary mask value and attendant address matching criteria.

The criteria essentially involve the selection of critical bit positions in a system base address, whose collective value is then to be compared against the collective value of similar selected bit positions in the receiver address contained in incoming frames. The resulting two values must be identical for a match to occur. This address filter is applied to all frames transmitted on the medium by other wireless stations and received at a current host system. If a frame passes the filter criteria, it is accepted into the current host system for further processing.

The address filter is programmed with a binary mask value which is applied in a logic AND operation to a receiver address field in each incoming frame. The receiver address field indicates the address of the intended recipient station for a given transmission instance of a given frame. The resulting value is compared against a match value which is similarly constructed by applying the same binary mask value in a logic AND operation against the base address for the system. Wireless stations that are emulated by the system are assigned, at the time they are created and initialized, an address that will conform to this constraint. When another wireless station on the network wishes to transmit a frame to an emulated station it designates the emulated station's conforming address as the receiver for the frame.

The address filter allows the system to selectively accept frames which are addressed to one of the system's emulated stations while ignoring other frames with a non-conforming receiver station address. Broadcast frames, as defined by the pertinent communications protocol specification, are accepted in all cases; multicast frames are similarly accepted, subject to validation of multicast group. The validation protocol is not part of the present invention but is constructed to conform the group to the general specification for the involved wireless communication medium.

The address filter is programmed once at system initialization and need not be further reprogrammed except as indicated by a desired change in system control policy. This makes for efficient use of the system processor and allows optimal use of the communications bandwidth of the wireless network.

The address mask has a format which corresponds to the physical device address format as defined by the applicable communications protocol specification. The address mask can be programmed with any binary value, affording the system user a great deal of flexibility in the range of conforming addresses that can be assigned to an emulated station. This also helps in test planning to prevent conflicts with the addresses of other wireless stations on the network, as well as conflicts with the addresses of any wireless stations being emulated by additional similar systems.

The binary mask value in the address filter may be changed at any time in order to redefine the body of conforming emulated stations being maintained in a given host system.

The objects, features, and advantages of the present invention will be apparent to the reader from the foregoing, the appended claims, and the ensuing detailed description of the invention taken in conjunction with the accompanying drawing.

### BRIEF DESCRIPTION OF THE DRAWINGS

FIG. 1 is a block diagram depicting a communications system which emulates multiple stations that communicate with other peers in a wireless network. Within the system's wireless interface is an address filter, which enables the system to selectively accept received frames on behalf of the emulated stations without compromising communications or processing efficiency; and

FIG. 2 is a block diagram which illustrates the operation of the address filter within the wireless interface of the host system shown in FIG. 1. The address filter allows incoming frames that are addressed to one of the system's emulated stations to pass through for further processing, while rejecting other frames.

### DETAILED DESCRIPTION OF THE INVENTION

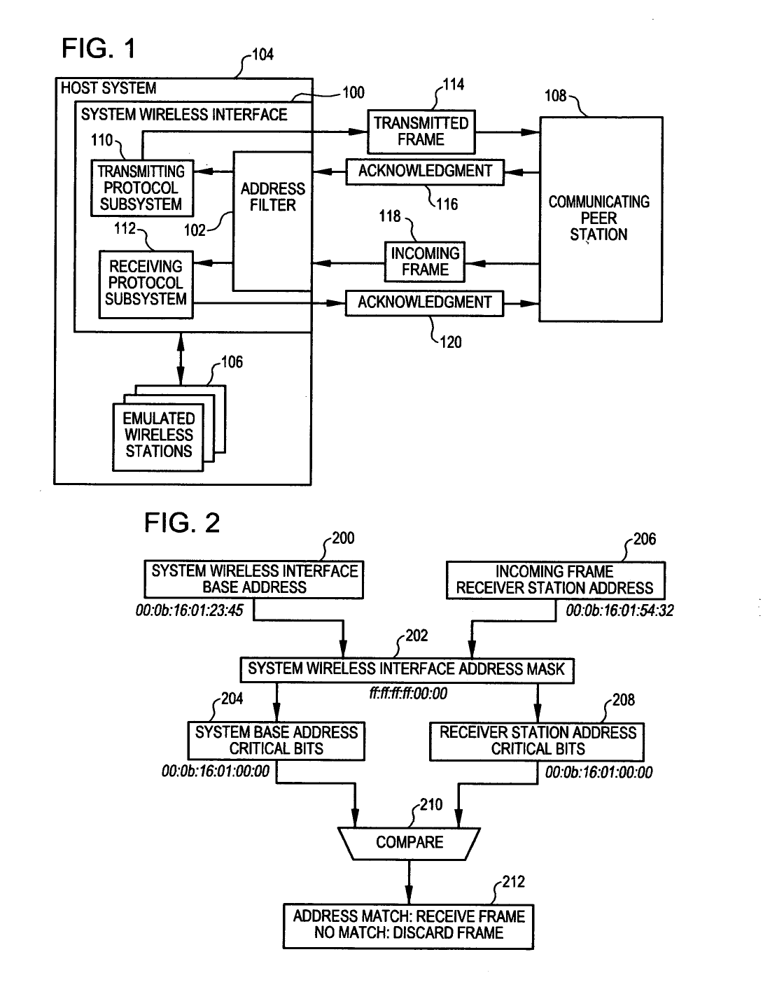

FIG. 1 depicts a communication system wireless interface 100, which: (a) includes an address filter 102, and (b) is a component of host system 104. The host system 104 emulates the operation of multiple wireless stations 106 in accordance with the wireless protocols prescribed by the specifications applicable to the particular communications network at hand. The emulated wireless stations 106 send data to and receive data from a communicating peer station 108 (i.e., another station on the network) via the services of the transmitting protocol subsystem 110 and receiving protocol subsystem 112, respectively, of the system wireless interface 100.

To send data, the transmitting protocol subsystem 110 prepares to transmit a packet or frame containing the data on behalf of the sending emulated station 106 and transmits the frame 114 on a radio channel or other suitable medium in accordance with the particular type of wireless network involved. The transmitted frame 114 includes the address of the sending emulated station 106 as the involved transmitter address and the address of the peer station 108 as the receiver address. When the peer station 108 to which the transmitted frame 114 is addressed successfully receives the frame, it sends an acknowledgement 116, indicating as the receiver the originating emulated wireless station 106.

The inbound acknowledgement frame 116 designates the address of the originating emulated wireless station 106 as the receiver address for this frame. This address is applied to the address filter 102 at the point of entry into the system wireless interface 100. If the addressing criteria of address filter 102 are met, the acknowledgement 116 is accepted for further processing and is applied to the transmitting protocol subsystem 110 to inform it of successful receipt by the intended receiver of the acknowledgment transmitted by peer station 108 to host system 104. In other words, if the filter address criteria are met—the acknowledgment frame can be accepted—the transmit protocol is made aware that the frame transmitted by host system 104 made it to its intended recipient (the communicating peer station 108). If the addressing criteria are not met, the acknowledgement 116 is rejected, and the transmitting protocol subsystem 110 may then go into its retry logic in accordance with a protocol which is not part of the present invention.

When the communicating peer station 108 has data to send to an emulated wireless station such as 106, it prepares a packet or frame containing the data and transmits it on the channel or medium. This incoming frame 118 (from the standpoint of host system 104) designates as the receiver address the address of the emulated station (here 106) that is the intended recipient of this data. When the incoming frame 118 is received at the system wireless interface 100, the receiver address contained in the frame is sent to address filter 102.

If the addressing criteria of address filter 102 are met, the incoming frame 118 is accepted for further processing, and is applied to the receiving protocol subsystem 112 for receipt into the system and subsequent consumption by the receiving emulated station 106. The receiving protocol subsystem 112 causes generation of an acknowledgement 120, which is transmitted back to the originating peer station 108, satisfying the requirements of the protocol.

The operation of system wireless interface address filter 102 is described in detail below with reference to FIG. 2.

Specifically, the system wireless interface 100 is configured with a base address 200. As an example, consider a communications protocol in which addresses are given in the form of a string of 6 octets (8-bit binary quantities). Each octet is expressed as a two-digit hexadecimal (base 16) number in the range 00 through ff. (n.b.: A hexadecimal digit represents a decimal value in the range 0 through 15 and is represented by a character in the range 0 through 9 and A through F (upper or lower case).) In the example at hand, the system wireless interface base address 200 has the value 00:0b:16:01:23:45.

The value of an address mask 202 is expressed in a binary format like that of the base address 200. In this example, the address mask 202 has the value ff:ff:ff:ff:00:00.

The base address 200 is logically combined in a bitwise AND operation with address mask 202 to derive the value of critical address bit positions 204 of base address 200. In a bitwise AND operation, bit positions in which both operands have the value “one” are retained, while bit positions in which either operand has the value “zero” are “masked out” (i.e. result in a zero). This increases efficiency by eliminating bit positions which are not relevant to the mask/comparison.

In this example, 00 AND ff=00, 0b AND ff=0b, etc. The resulting value of the system base address critical bits 204 in the example is 00:0b:16:01:00:00.

By a similar process, the receiver address of an incoming frame 206 is passed through address mask 202 to derive receiver station address critical bits 208, an inbound acknowledgement such as discussed above and identified by reference character 116 being treated the same as an incoming frame 206 in this regard. In this example, the incoming frame receiver address 206 has the value 00:0b:16:01:54:32. After being combined with the address mask 202, the resulting receiver station address critical bits 208 have the value 00:0b:16:01:00:00.

When any inbound frame (e.g., 206) is considered for acceptance, its receiver address critical bits value 208 is computed and compared as shown at 210 with the system base address critical bits 204. If the two values are equal, the frame is accepted as shown at 212 for further processing by the system. If they do not match, the frame is ignored.

In the example under discussion, the critical bits of both the receiver-station address and the address mask have the same value—00:0b:16:00:00. The address values match, and the frame is therefor accepted into host computer 104 for further processing.

The above-disclosed manipulation and coordination of a system base address, an address mask, and the configured addresses of emulated wireless stations such as those identified by reference character 106 allows a user to construct powerful and flexible sets of test station populations for wireless network tests. All emulated stations 106 will normally be configured such that their addresses match the characteristics of the system base address 200 plus the address mask 202.

Additional emulated stations whose addresses do not satisfy the constraints of base address 200 plus address mask 202 may be defined, allowing for “negative test cases” in which protocol requirements are purposely not met. In this case the system would allow the transmission of frames ostensibly sent by the purposely misconfigured emulated station to a communicating peer, but would prevent the system from accepting for receipt any frames which come within the meaning and range of equivalency of the claims are intended to be embraced therein.

1. A method of so operating a wireless communication system which has a plurality of emulated wireless stations that only transmitted data frames addressed to one of the emulated stations will be received, this method comprising the steps of:
providing a host system which has a plurality of virtual wireless stations and the capability of receiving data frames transmitted to the host system from a communication peer station;
applying to all transmitted data frames received at the host system an address filter with the capability of identifying a receiver address embedded in each of the transmitted data frames;
comparing the identified data frame address with a base address of the host system; and
accepting into the host system only those data frames with identified addresses that match the base address of the host system.

2. A method as defined in claim 1 wherein:
the address filter is programmed with a binary mask value;
the binary mask value is applied in a logic AND operation to the incoming frame receiver address in each incoming frame; and
the value derived from the AND operation is compared to a match value.

3. A method as defined in claim 2 in which the match value is the result obtained by applying the binary mask value in a logic AND operation to the host system base address.

4. A method as defined in claim 1 which comprises the step of programming the address filter at initialization of the host system.

5. A method as defined in claim 1 which includes the step of changing the binary mask value in the address filter.

6. A method as defined in claim 1 in which the host system base address and the address mask values are expressed as a string of hexadecimal digits.

7. A method as defined in claim 1 in which the address filter comprises a binary address mask value and address matching criteria.

8. A method as defined in claim 7 in which:
the binary value of the address mask is used to select address bits for subsequent comparison;
address bits in each bit position where the corresponding bit in the address mask has the value 1 are used in the comparison; and
address bits in each bit position where the corresponding bit in the address mask has the value 0 are ignored in the comparison.

9. A method as defined in claim 7 in which:
the AND operation is performed in a bitwise manner to apply the binary value of the address mask to the binary value of an address and produce a masked address value for comparison with another masked address value;
each bit position in which both the address operand and the address mask operand have the value 1 produces the value 1 in that bit position of the masked address value comparison result; and
each bit position in which either the address operand or the address mask operand has the value 0 produces the value 0 in that bit position of the masked address value comparison result.

10. A wireless communication host system which comprises:
a plurality of emulated wireless stations, each of those stations having the capability of accepting data addressed to it in a frame transmitted from a peer station to the host system; and
an address filter for rejecting all data frames which: (a) are transmitted from the peer station to the host system but (b) are not addressed to a virtual station of the host system.

11. A wireless communication system as defined in claim 10 which has a transmitting protocol subsystem and a receiving protocol subsystem for transmitting data frames to and receiving data frames from a communicating peer station.

12. A wireless communication system as defined in claim 10 in which:
the address filter comprises a base address and an address mask and the capability of:
so combining the base address and the address mask as to generate a base address value of the system;
so combining the receiver address of an incoming data frame and the address mask as to generate an incoming frame receiver address value; and
so comparing the system base address value and the incoming frame receiver address as to determine if the two values are equal and the incoming data frame is to accordingly be accepted by the host system.

13. A system as defined in claim 10 in which the address filter comprises a binary mask value and address matching criteria.
